(19) United States
(12) Patent Application Publication
(10) Pub. No.: US 2023/0105470 A1
(43) Pub. Date: Apr. 6, 2023

(54) DRIVING ASSISTANCE APPARATUS AND DRIVING ASSISTANCE METHOD

(71) Applicant: TOYOTA JIDOSHA KABUSHKI KAISHA, Toyota-shi Aich-ken (JP)

(72) Inventor: Tadashi SEKIGUCHI, Ashigarakami-gun Kanagawa (JP)

(73) Assignee: TOYOTA JIDOSHA KABUSHKI KAISHA, Toyota-shi Aichi-ken (JP)

(21) Appl. No.: 17/954,611

(22) Filed: Sep. 28, 2022

(30) Foreign Application Priority Data
Oct. 5, 2021 (JP) 2021-164147

(51) Int. Cl. B62D 6/00; B62D 15/02

(52) U.S. Cl. CPC B62D 6/00; B62D 15/025; B62D 15/029

(57) ABSTRACT

A driving assistance apparatus is capable of executing steering control that includes steering assistance or automatic steering of a vehicle. The driving assistance apparatus includes: an influence information acquisition unit configured to acquire influence information including information on a road affected by irregularities on the road; a proposal information presentation unit configured to present proposal information related to suspension of the steering control to an occupant of the vehicle when the influence information on road affected by irregularities present along a path of the vehicle is acquired during execution of the steering control; and a steering control unit configured to suspend a part or all of the steering control based on a suspending operation of the steering control from the occupant.

### TECHNICAL FIELD

The present disclosure relates to a driving assistance apparatus and a driving assistance method.

### CROSS- REFERENCE TO RELATED APPLICATION

This application claims the benefit of priority from Japanese Patent Application No. 2021-164147, filed on Oct. 5, 2021, the entire contents of which are incorporated herein by reference.

### BACKGROUND

A driving assistance apparatus that receives construction information related to a construction section including both a construction area where construction work is performed and a non-construction area on a side of the construction area is known (for example, Japanese Patent Application Laid-Open No. 2014-67165). This apparatus performs driving assistance of a vehicle passing through the construction section, based on the construction information.

In the above-described conventional driving assistance apparatus, driving assistance is actively executed even when passing through a construction section. However, a scope of the construction area in which the construction work is performed may vary depending on, for example, contents of the construction work. Therefore, even though the construction information is used, an occupant of the vehicle may be caused to feel uneasy when the vehicle passes through the construction section with the driving assistance being executed.

In this technical field, it is desired to provide room for the occupant's intention to intervene in continuing execution of the driving assistance when irregularities on a road are present on a path of the vehicle.

### SUMMARY

An example driving assistance apparatus is capable of executing steering control that includes steering assistance or automatic steering of a vehicle. The driving assistance apparatus includes: an influence information acquisition unit configured to acquire influence information including information on a road affected by irregularities on the road; a proposal information presentation unit configured to present proposal information related to suspension of the steering control to an occupant of the vehicle when the influence information on road affected by irregularities present along a path of the vehicle is acquired during execution of the steering control; and a steering control unit configured to suspend a part or all of the steering control based on a suspending operation of the steering control from the occupant.

According to an example driving assistance apparatus, influence information including information on the road affected by irregularities on the road is acquired. Proposal information related to suspension of steering control is presented to the occupant of the vehicle when influence information on the irregularities on the road along the path of the vehicle is acquired during execution of steering control. The occupant of the vehicle is given an opportunity to examine whether to continue or suspend steering control based on the proposal information. Some or all of the steering control is suspended based on a suspending operation of the steering control from the occupant. Therefore, it is possible to provide room for the occupant's intention to intervene in the continuing execution of the driving assistance when irregularities on the road are present on the path of the vehicle.

In some examples, the influence information may include information on irregularity occurrence positions on the road associated with the irregularities. The proposal information presentation unit may present information on the irregularity occurrence position to the occupant when the influence information on road affected by irregularities present along the path of the vehicle is acquired during the execution of the steering control.

In some examples, the influence information may include information on irregularity occurrence positions on the road associated with the irregularities. The proposal information presentation unit may present the proposal information to the occupant when a time taken for the vehicle to reach an influence section including the irregularity occurrence position is equal to or less than a first threshold, or when a distance taken for the vehicle to reach the influence section is equal to or less than a second threshold.

In some examples, the proposal information presentation unit may re-present the proposal information to the occupant vocally when there is no suspending operation of the steering control from the occupant within a predetermined time from when the proposal information presentation unit presents the proposal information to the occupant.

In some examples, the proposal information presentation unit may omit presentation of the proposal information, when the road affected by irregularities is a road shoulder and a traveling lane of the vehicle is not adjacent to the road shoulder.

Another example of a driving assistance method includes: acquiring influence information that includes information on a road affected by irregularities on the road; presenting proposal information related to suspension of steering control to an occupant of a vehicle when the influence information on road affected by irregularities present along a path of the vehicle is acquired during execution of the steering control that includes steering assistance or automatic steering of the vehicle; and suspending a part or all of the steering control based on a suspending operation of the steering control from the occupant.

According to another example of a driving assistance method, influence information including information on a road affected by irregularities on the road is acquired. Proposal information related to suspension of the steering control is presented to the occupant of the vehicle when influence information on the path of the vehicle is acquired during execution of the steering control. The occupant of the vehicle is given an opportunity to examine whether to continue or suspend steering control based on the proposal information. Some or all of the steering control is suspended based on a suspending operation of the steering control from the occupant. Therefore, it is possible to provide room for the occupant's intention to intervene in the continuing execution of the driving assistance when irregularities on the road are present on the path of the vehicle.

According to various examples, it is possible to provide room for the occupant's intention to intervene in the continuing execution of the driving assistance when irregularities on the road are present on the path of the vehicle.

### BRIEF DESCRIPTION OF THE DRAWINGS

FIG. 1 is a block diagram illustrating a configuration of a driving assistance apparatus according to an embodiment.

FIG. 2A is a schematic plan view illustrating a situation in which a traveling lane of the vehicle is adjacent to the lane affected by irregularities that is not a road shoulder.

FIG. 2B is a schematic plan view illustrating a situation in which a traveling lane of the vehicle is the same as the lane affected by irregularities that is not a road shoulder.

FIG. 3A is a schematic plan view illustrating a situation in which the road affected by irregularities is a road shoulder and a traveling lane of the vehicle is not adjacent to the road shoulder.

FIG. 3B is a schematic plan view illustrating a situation in which the road affected by irregularities is a road shoulder and a traveling lane of the vehicle is adjacent to the road shoulder.

FIG. 4 is a flowchart illustrating an information presentation process of the ECU of FIG. 1.

FIG. 5 is a flowchart illustrating assistance suspension processing of the ECU of FIG. 1.

FIG. 6 is a flowchart illustrating an information re-presentation process of the ECU of FIG. 1.

### DETAILED DESCRIPTION

Hereinafter, embodiments of the present disclosure will be described with reference to the drawings. In the following description, the same or corresponding elements are denoted by the same reference numerals, and redundant description is omitted.

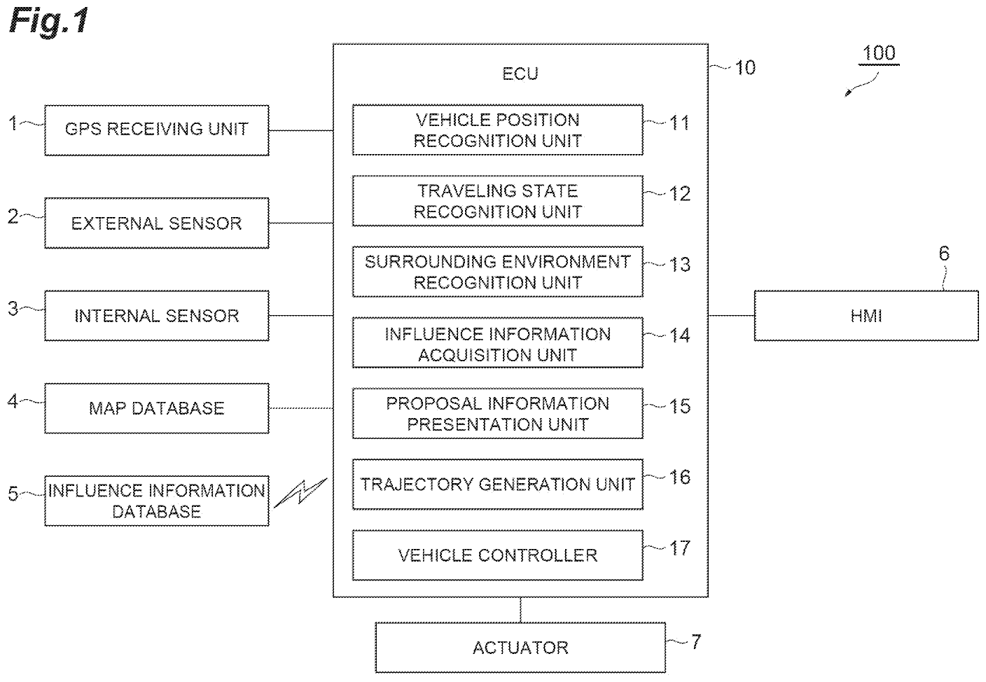

FIG. 1 is a block diagram showing a configuration of a driving assistance apparatus according to an embodiment. A driving assistance apparatus 100 shown in FIG. 1 is an automatic operation device mounted on a vehicle such as a passenger car. The driving assistance apparatus 100 is configured to be able to execute steering control including steering assistance or automatic steering of the vehicle. The steering assistance is a driving state for performing control so as to assist the steering operation of the vehicle by the driver. The steering assistance is, for example, control for urging the driver to perform a steering operation of the vehicle so as not to deviate from the traveling lane. The automatic steering is a driving state in which the steering of the vehicle is automatically controlled. Automatic steering refers to, for example, control (LKA [Lane Keeping Assist]) for automatically steering a vehicle so as not to deviate from a traveling lane. The automatic steering may be a lane keeping function for keeping a vehicle in a lane during a predetermined operation in an expressway or the like. The predetermined operation may be a traffic jam at a vehicle speed of 60 km/h or less in an expressway or the like, for example.

The driving assistance apparatus 100 may be configured to be capable of performing autonomous driving. Autonomous driving is vehicle control in which a vehicle is automatically driven along a preset target route. In autonomous driving, the driver does not need to perform driving operations such as steering and acceleration/deceleration, and the vehicle travels automatically. The target route is a path on the map along which the vehicle travels in autonomous driving control. For autonomous driving, SAE [Society of Automotive Engineers] Autonomous driving level 2 to autonomous driving level 4 in the J3016 may be included.

That is, the steering control of the present embodiment means lane trace control including at least one of steering assistance, automatic steering, and autonomous driving. The driving assistance apparatus 100 can make a request of a take over of a driving operation to an occupant (for example, a driver) while steering control is being executed (described in detail later).

[Configuration of the Driving Assistance Apparatus 100]

As illustrated in FIG. 1, the driving assistance apparatus 100 includes an electronic control unit (ECU) 10 that controls steering control. The ECU 10 is an electronic control unit that includes a CPU [Central Processing Unit], ROM [Read Only Memory], RAM [Random Access Memory], CAN [Controller Area Network] communication circuit or the like. In the ECU 10, for example, a program stored in the ROM is loaded into the RAM, and the program loaded into the RAM is executed by the CPU to implement various functions. The ECU 10 may consist of a plurality of electronic control units.

The ECU 10 is connected to a Global Positioning System (GPS) receiving unit 1, an external sensor 2, an internal sensor 3, a map database 4, an influence information database 5, HMI [Human Machine Interface] 6 and an actuator 7.

The GPS receiving unit 1 measures the position of the vehicle (for example, the latitude and longitude of the vehicle) by receiving signals from three or more GPS satellites. The GPS-receiving unit 1 transmits the measured position information of the vehicle to the ECU 10.

The external sensor 2 is a detector that detects a situation around the vehicle. The external sensor 2 includes at least one of a camera and a radar sensor.

The camera is an imaging device that images an external situation of a vehicle. The camera is provided on the back side of the windshield of the vehicle. The camera transmits a captured image of the external situation of the vehicle to the ECU 10. The camera may be a monocular camera, or may be a stereo camera. The stereo camera includes two imaging units arranged so as to reproduce binocular parallax. The captured image of stereo camera also includes information in the depth direction.

The radar sensor is a detector that detects an obstacle around the vehicle by using radio waves (for example, millimeter waves) or light. The radar sensor includes, for example, a millimeter wave radar or a light detection and ranging (LIDAR). The radar sensor detects an obstacle by transmitting radio waves or light to the surroundings of the vehicle and receiving radio waves or light reflected from the obstacle. The radar sensor transmits the detected obstacle information to the ECU 10. The obstacle includes a guardrail and a fixed obstacle such as a building. The fixed obstacle includes a security device such as a sign temporarily installed for road construction, roadblocks for road construction, fence, or safety cone. The obstacle includes a moving obstacle such as a pedestrian, a bicycle, and an other vehicle. The moving obstacle includes a construction vehicle for road construction, a roadworker, and the like.

The internal sensor 3 is a detector that detects the traveling state of the vehicle. The internal sensor 3 includes a vehicle speed sensor, an acceleration sensor, and a yaw rate sensor. The vehicle speed sensor is a detector that detects the speed of the vehicle. As the vehicle speed sensor, for example, a wheel speed sensor that is provided on a wheel of a vehicle or a drive shaft that rotates integrally with the wheel and detects the rotational speed of the wheel is used. The vehicle speed sensor transmits detected vehicle speed information (wheel speed information) to the ECU 10.

The acceleration sensor is a detector that detects acceleration of the vehicle. The acceleration sensor includes, for example, a longitudinal acceleration sensor that detects acceleration in the longitudinal direction of the vehicle, and a lateral acceleration sensor that detects lateral acceleration of the vehicle. The acceleration sensor transmits, for example, acceleration information of the vehicle to the ECU 10. The yaw rate sensor is a detector that detects a yaw rate (rotational angular velocity) around the vertical axis of the center of gravity of the vehicle. As the yaw rate sensor, for example, a gyro sensor can be used. The yaw rate sensor transmits yaw rate information of the detected vehicle to the ECU 10.

The map database 4 is a database that stores map information. The map database 4 is formed in a storage device such as a hard disk drive (HDD) mounted on a vehicle, for example. The map information includes position information of roads, information of road shapes (for example, types of curves and straight portions, curvature of curves, and the like), position information of intersections and branch points, and the like. The map database 4 may be provided in a facility or the like remote from the vehicle as a sever capable of communicating with the vehicle. The storage device of the map database 4 is not limited to the HDD and may be a solid state drive (SDD). An optical disk, a semiconductor memory, a flash memory, or the like may be used. The map information of the map database 4 may include road information such as the number of lanes of a road and the presence or absence of a road shoulder and a roadside band in association with the position information.

The influence information database 5 is a database in which influence information is stored. The influence information database 5 may have a configuration similar to that of a well-known database storage medium such as an HDD. The influence information database 5 may be provided in a facility remote from the vehicle (for example, a facility such as an information management center that manages traffic information) or the like.

Influence information includes information on a road affected by irregularities on the road. The influence of the irregularities on the road means that traveling with steering control of the vehicle becomes difficult or a desired margin cannot be obtained in a lane influenced by the irregularities.

Here, the “road” includes a lane, a road shoulder, or a roadside band. The lane is a portion of a road on which the vehicle is travelable. The road shoulder refers to a portion of a belt-shaped road that is connected to a sidewalk, a roadway, a bicycle road, or a bicycle pedestrian road in order to protect the main structural portion of the road or maintain the utility of the roadway. The roadside band is a portion of a road having no sidewalk or a belt-like road provided on the roadside on the side of the road having no sidewalk, which is partitioned by road marking, in order to serve traffic of pedestrian or maintain utility of the roadway.

The irregularities on a road means an obstruction on a road that has a difficulty to pass through influence on a portion of the road. The irregularities on a road include road construction, obstacle (for example, fallen object) present on the road, accident occurred on the road, and freezing of a specific lane. The information on the irregularities on the road includes, for example, information that can be acquired from servers of government and public offices that control traffic, and an irregularity occurrence position indicating a specific portion (at least one of a lane, a road shoulder, and a roadside band) on the road where each the irregularities occurs.

The irregularity occurrence position is information related to a position on a road associated with the irregularities and is included in influence information. The irregularity occurrence position is included in the influence section. Influence section means a scope that is affected by the irregularities on a road by difficulty to pass through. The scope affected by difficulty to pass through may be, for example, a section along an extending direction of a lane in which construction work is being performed and which is occupied for construction work in the lane.

The influence section has higher accuracy than the construction section and the like included in traffic-related information that can be acquired via conventional traffic-related information (for example, VICS [Vehicle Information and Communication System], registered trademark). The “high accuracy” may be an aspect in which information on whether or not the position along the extending direction of the lane in each lane is affected by difficulty to pass through by the irregularities on the road is associated with a position having a higher density than the conventional traffic-related information

The HMI 6 is an interface for inputting and outputting information between the driving assistance apparatus 100 and an occupant (including a driver). The HMI 6 includes a display. The HMI 6 outputs an image on the display in response to a control signal from the ECU 10.

The display is a display device provided in a vehicle so as to be visible to a driver. The display is provided in a dashboard of a vehicle, for example. The display has a display screen for displaying an image to the driver. The display displays an image on a display screen based on a control signal from the ECU 10. The display may include a head up display (HUD) that performs projection display on a windshield or a projection screen of the vehicle.

The HMI 6 may include a speaker. The HMI 6 may perform audio output from the speaker in response to a control signal from the ECU 10. The speaker is an audio output device that is mounted on a vehicle and performs audio output to an occupant. The speaker is provided inside a door of a driver's seat, for example. The speaker outputs audio based on a control signal from the ECU 10.

The HMI 6 includes an input device that receives a suspending operation (described below) of the steering control from the occupant. Examples of the input device include a touch panel and a switch provided on a steering wheel of a vehicle. The display may be a touch panel. The HMI 6 transmits input information of the detected suspending operation to the ECU 10.

The actuator 7 is a device used to control the vehicle. The actuator 7 includes at least a drive actuator, a brake actuator, and a steering actuator. The drive actuator controls the amount of air supplied to the engine (throttle opening) in response to a control signal from the ECU 10, and controls the driving force of the vehicle. When the vehicle is a hybrid electric vehicle, in addition to the amount of air supplied to the engine, a control signal from the ECU 10 is input to the motor serving as a power source to control the driving force. When the vehicle is a battery electric vehicle, a control signal from the ECU 10 is input to a motor as a power source to control the driving force. The motor as a power source in these cases constitutes the actuator 7.

The brake actuator controls the braking system in response to a control signal from the ECU 10 to control the braking force applied to the vehicle wheels. As the brake system, for example, a hydraulic brake system can be used. The steering actuator controls driving of an assist motor for controlling steering torque in an electric power steering system according to a control signal from a ECU 10. Accordingly, the steering actuator controls the steering torque of the vehicle.

Next, the functional configuration of the ECU 10 will be described. The ECU 10 has a vehicle position recognition unit 11, a traveling state recognition unit 12, a surrounding environment recognition unit 13, an influence information acquisition unit 14, a proposal information presentation unit 15, a trajectory generation unit 16, and vehicle control unit (steering control unit) 17. Some of the functions of the ECU 10 may be performed on servers in communication with the vehicle.

The vehicle position recognition unit 11 recognizes the position of the vehicle on the map based on the position information of the GPS-receiving unit 1 and the map database 4 information of the map unit. The vehicle position recognition unit 11 may perform simultaneous localization and mapping (SLAM) by using position information of a landmark included in the map database 4 and a detection result of the external sensor 2 by a technique or the like. Thereby the vehicle position recognition unit 11 accurately recognizes the position of a vehicle. The vehicle position recognition unit 11 may recognize the position of the vehicle on the map by other known methods.

The traveling state recognition unit 12 recognizes the traveling state of the vehicle based on the detection result of the internal sensor 3. The traveling state includes a vehicle speed of the vehicle, an acceleration of the vehicle, and a yaw rate of the vehicle. To be more specific, the traveling state recognition unit 12 recognizes the vehicle speed of the vehicle based on vehicle speed information of the vehicle speed sensor. The traveling state recognition unit 12 recognizes the direction of the vehicle based on the yaw rate information of the yaw rate sensor.

The surrounding environment recognition unit 13 recognizes the surrounding environment of the vehicle based on a detection result of the external sensor 2 (obstacle information of a radar sensor or imaging information of a camera). The surrounding environment includes a situation of an obstacle (including another vehicle) around the vehicle and a situation of a lane line (for example, a lane line) around the vehicle. The surrounding environment recognition unit 13 recognizes a lane line around the vehicle and recognizes a traveling lane of the vehicle based on, for example, a captured image of the camera. When the position of the vehicle on the map is recognized, the surrounding environment recognition unit 13 may recognize the lane using map information.

The influence information acquisition unit 14 acquires influence information stored in the influence information database 5. The influence information acquisition unit 14 acquires influence information via, for example, a communication network (for example, the Internet,

VICS, or the like). The influence information acquisition unit 14 may acquire the influence information by road-to-vehicle communication with a roadside transceiver (for example, an optical beacon or an intelligent transport system (ITS) spot or the like) provided on the roadside. The influence information acquisition unit 14 may have a vehicle-to-vehicle communication function.

When influence information on the irregularities on the road along the path of the vehicle is acquired while steering control is being performed, the proposal information presentation unit 15 presents proposal information on suspension of steering control to an occupant of the vehicle. Here, “on the road along the path of the vehicle” means on a road that is positioned in the traveling direction of the vehicle in which the steering control is being executed and includes a lane on which the vehicle is traveling. The proposal information presentation unit 15 determines whether the influence information on the path of the vehicle has been acquired based on, for example, the acquired influence information, the recognition result of the vehicle position recognition unit 11, and the map information. For example, when influence information indicating that the irregularities are generated in at least a part of a road including a lane in which a vehicle in which steering control is being executed travels is acquired by the influence information acquisition unit 14, the proposal information presentation unit 15 determines that influence information on a path of the vehicle is acquired.

The proposal information presentation unit 15 presents proposal information to the occupant of the vehicle by, for example, transmitting a control signal to the display of the HMI 6. The proposal information is information for prompting the occupant of the vehicle to examine the temporary suspension of the steering control. Presentation of proposal information to an occupant of a vehicle corresponds to take over request of a driving operation in an automatic operation device having a lane keeping function. The proposal information may be, for example, operation button image with characters such as “interruption of steering control” displayed on the display (touch panel) of the HMI 6.

When influence information on the path of the vehicle is acquired during the steering control, the proposal information presentation unit 15 may present information on the irregularity occurrence position to the occupant. The proposal information presentation unit 15 presents information on the irregularity occurrence position to the occupant of the vehicle by transmitting a control signal to the display of the HMI 6, for example. For example, the proposal information presentation unit 15 may superimpose an influence section on a navigation map on a display and present information on an irregularity occurrence position to occupants of the vehicle. The proposal information presentation unit 15 may present information on the irregularity occurrence position to an occupant of the vehicle by displaying a place name or a kilometer post information specifying the irregularity occurrence position or influence section on the display, for example.

The proposal information presentation unit 15 may present the proposal information to the occupant when a time until the vehicle reaches an influence section including an irregularity occurrence position is equal to or less than a first threshold. First threshold is a time threshold corresponding to an opportunity for an occupant to consider whether or not to continue steering control based on proposed proposal information. The proposal information presentation unit 15 may determine whether or not the time until the vehicle reaches the influence section is equal to or less than the first threshold based on the recognition result of the vehicle position recognition unit 11, the vehicle speed recognized by the traveling state recognition unit 12, and the irregularity occurrence position, for example.

The proposal information presentation unit 15 may present the proposal information to the occupant when a distance until the vehicle reaches an influence section including an irregularity occurrence position is equal to or less than a second threshold. Second threshold is a threshold value of a distance corresponding to an opportunity for the occupant to consider whether to continue the steering control based on the proposed proposal information. For example, the proposal information presentation unit 15 may determine whether or not the distance until the vehicle reaches the influence section is equal to or less than the second threshold based on the recognition result of the vehicle position recognition unit 11 and the irregularity occurrence position.

If there is no suspending operation of steering control from the occupant within a predetermined time after the proposal information is presented to the occupant, the proposal information presentation unit 15 may re-present the proposal information to the occupant in audio. The predetermined time is a threshold value of time for determining whether to re-present proposal information in audio to an occupant. The predetermined time is a time for waiting for suspending operation of steering control from an occupant. The predetermined time is a time during which the possibility that the occupant has overlooked the presentation of the proposal information is equal to or greater than a certain value.

When the proposal information is re-presented to the occupant, audio may be used, or vibration may be imparted to the occupant via steering, seat belt, or the like. However, when the proposal information is first presented to the occupant, display on a display or the like is used instead of audio and vibration.

The suspending operation of the steering control is an operation by the occupant of the vehicle to inform the driving assistance apparatus 100 of the intention to take over the manual driving. That is, the suspending operation of the steering control is an operation in which the intention of the occupant to interrupt the steering control and take over the steering control to the manual driving intervenes. Suspending operation of steering control is performed by an occupant of the vehicle according to proposed proposal information.

For example, the proposal information presentation unit 15 may determine whether there is no suspending operation of the steering control from the occupant within a predetermined time after the proposal information is presented to the occupant based on whether a time during which the suspending operation is not detected in the HMI 6 since the proposal information is presented to the occupant of the vehicle exceeds the predetermined time. For example, the proposal information presentation unit 15 transmits a control signal to a speaker of the HMI 6 to re-present the proposal information to the occupant in audio.

The proposal information presentation unit 15 may omit presentation of proposal information if the road affected by the irregularities is a road shoulder and the traveling lane of the vehicle is not adjacent to the road shoulder. The proposal information presentation unit 15 determines whether the road affected by the irregularities is a road shoulder based on, for example, the information on the road affected by the irregularities on the road and the irregularity occurrence position. For example, the proposal information presentation unit 15 determines whether the traveling lane of the vehicle is not adjacent to the road shoulder based on the information on the road affected by the irregularities on the road, the irregularity occurrence position, and the recognition result of the vehicle position recognition unit 11.

The trajectory generation unit 16 generates a trajectory used when the vehicle performs autonomous driving. The trajectory generation unit 16 generates a trajectory of autonomous driving by various methods based on a destination set in advance, map information of the map database 4, a position on the map of the vehicle recognized by the vehicle position recognition unit 11, a traveling state (vehicle speed, yaw rate, and the like) of the vehicle recognized by the traveling state recognition unit 12, and surrounding environment recognized by the surrounding environment recognition unit 13. The destination may be set by an occupant of the vehicle, or may be a destination automatically suggested by a known navigation system.

The vehicle controller 17 suspends some or all of the steering controls based on the suspending operation of the steering controls from the occupants. For example, the vehicle controller 17 may determine whether there is a suspending operation of steering control from an occupant based on whether a suspending operation is detected by a HMI 6 (a touch panel, a switch provided in a steering wheel of a vehicle, or the like).

The suspending operation of the steering control may be an override operation by an occupant of the vehicle. For example, the vehicle controller 17 may determine whether there is a suspending operation of the steering control from the occupant based on whether the steering operation by the occupant is detected by a steering sensor or the like. For example, the vehicle controller 17 may determine whether there is a suspending operation of steering control from the occupant based on whether an accelerator operation by the occupant is detected by an accelerator position sensor or the like. The vehicle controller 17 may determine whether there is suspending operation of steering control from the occupant based on whether brake operation by the occupant is detected by a brake pedal sensor or the like, for example.

When the vehicle performs autonomous driving, the vehicle controller 17 may function to perform autonomous driving of the vehicle based on the position of the vehicle recognized by the vehicle position recognition unit 11 on the map, the traveling state of the vehicle recognized by the traveling state recognition unit 12, the surrounding environment recognized by the surrounding environment recognition unit 13, and the trajectory generated by the trajectory generation unit 16. The vehicle controller 17 executes autonomous driving by causing the vehicle to travel along a trajectory, for example. The vehicle controller 17 may perform autonomous driving by a well-known method.

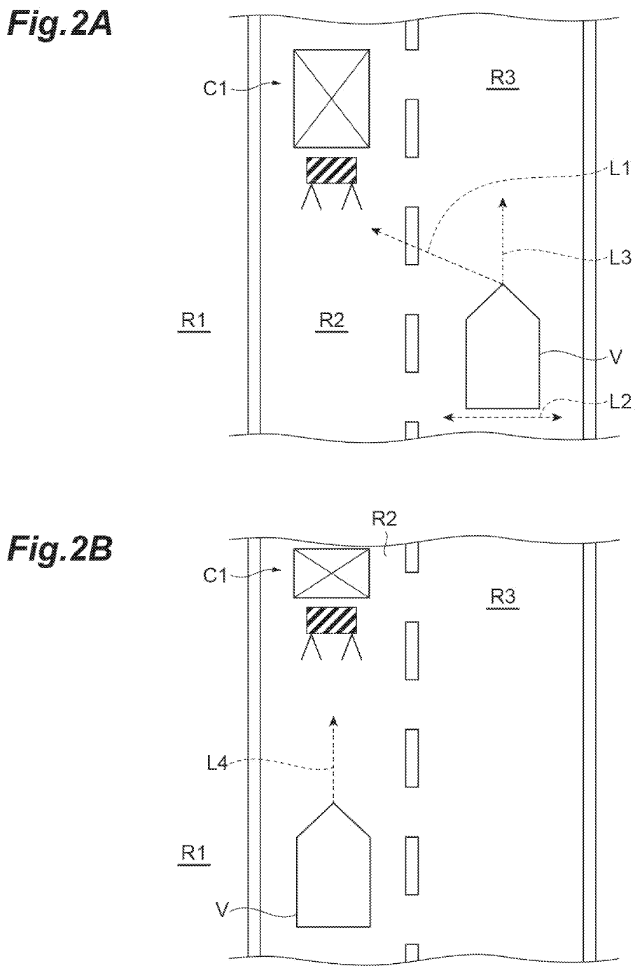

FIG. 2A is a schematic plan view illustrating a situation in which a road affected by the irregularities is a lane that is not a road shoulder and a traveling lane of a vehicle is adjacent to the lane. FIG. 2B is a schematic plan view illustrating a situation in which the road affected by the irregularities is a lane that is not a road shoulder and the traveling lane of the vehicle is the lane.

In the illustrated FIG. 2A example, the road affected by a road construction C1 is a lane R2. The traveling lane of a vehicle V is a lane R3 adjacent to the lane R2. When the suspending operation of the steering control from the occupant is detected, the vehicle controller 17 may interrupt the steering control that performs a lane change across lanes from the lane R3 to the lane R2 as indicated by a dashed line L1 as a part of the steering control. When the suspending operation of the steering control from the occupant is detected, the vehicle controller 17 may interrupt the steering control for controlling the lateral position of the lane width direction in the lane R3 as indicated by a dashed line L2 as a part of the steering control. When the suspending operation of the steering control from the occupant is detected, the vehicle controller 17 may stop all of the steering control as indicated by a dashed line L3 and allow the vehicle to travel by manual driving of the occupant of the vehicle. The vehicle controller 17 may interrupt all of the steering controls in response to an override operation by the occupant of the vehicle even when a suspending operation of the steering controls from the occupant is not detected in the HMI 6.

In the illustrated FIG. 2B example, the road affected by the road construction C1 is the lane R2. The traveling lane of the vehicle V is the lane R2. When the suspending operation of the steering control from the occupant is detected, the vehicle controller 17 may stop all of the steering control as indicated by a dashed line L4 and allow the vehicle to travel by manual driving of the occupant of the vehicle. The vehicle controller 17 may interrupt all of the steering controls in response to an override operation by the occupant of the vehicle even when a suspending operation of the steering controls from the occupant is not detected in the HMI 6.

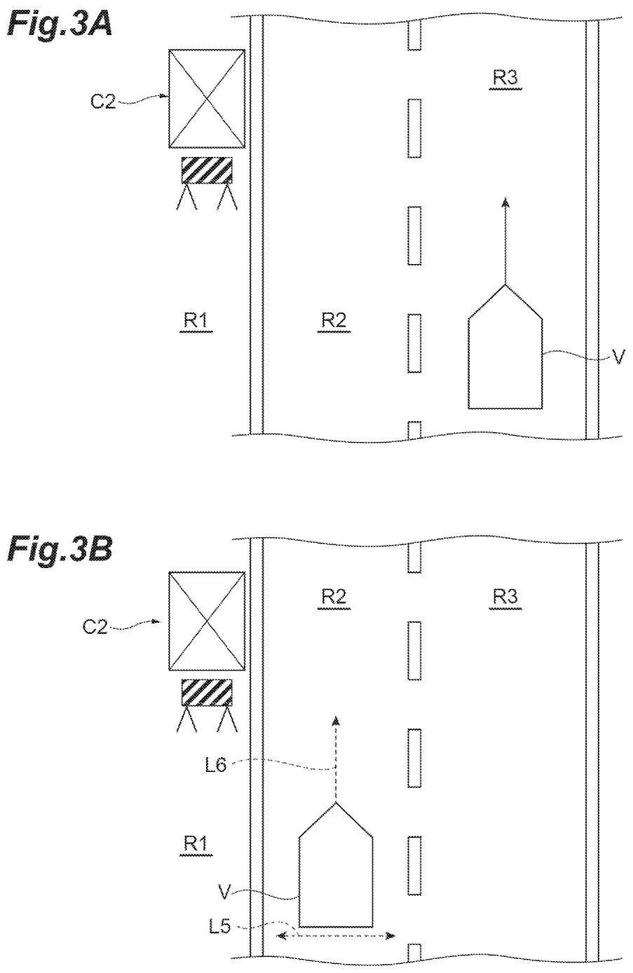

FIG. 3A is a schematic plan view illustrating a situation where the road affected by the irregularities is a road shoulder and the traveling lane of the vehicle is not adjacent to the road shoulder. FIG. 3B is a schematic plan view illustrating a situation where the road affected by the irregularities is a road shoulder and the vehicle's traveling lane is adjacent to the road shoulder.

In the illustrated FIG. 3A example, the road affected by a road construction C2 is a road shoulder R1. The traveling lane of the vehicle V is the lane R3 that is not adjacent to the road shoulder R1. The proposal information presentation unit 15 may present proposal information to an occupant of the vehicle. In this case, if the suspending operation of the steering control from the occupant is not detected in the HMI 6, the vehicle controller 17 may continue the steering control. Alternatively, the proposal information presentation unit 15 may omit the presentation of proposal information.

In the illustrated FIG. 3B example, the road affected by the road construction C2 is the road shoulder R1. The traveling lane of the vehicle V is the lane R2 adjacent to the road shoulder R1. When the suspending operation of the steering control from the occupant is detected, the vehicle controller 17 may interrupt the steering control for controlling the lateral position of the lane width direction in the lane R2 as indicated by a dashed line L5 as a part of the steering control. When the suspending operation of the steering control from the occupant is detected, the vehicle controller 17 may stop all of the steering control as indicated by a dashed line L6 and allow the vehicle to travel by manual driving of the occupant of the vehicle. The vehicle controller 17 may interrupt all of the steering controls in response to an override operation by the occupant of the vehicle even when a suspending operation of the steering controls from the occupant is not detected in the HMI 6.

In addition, the vehicle controller 17 may restore some or all of the steering controls that have been suspended based on the resume operation of the steering controls from the occupant. The resume operation of the steering control is an operation by the occupant of the vehicle to inform the driving assistance apparatus 100 of the intention of take over from manual driving to steering control. A specific example of the resume operation may be an operation similar to the suspending operation described above. The vehicle controller 17 may automatically restore some or all of the steering controls that have been suspended. For example, in a case where elapsed time after the vehicle passes through an influence section including an irregularity occurrence position is equal to or greater than a third threshold, the vehicle controller 17 may automatically restore a part or all of the steering control that has been suspended. The third threshold is a threshold of elapsed time for automatically returning a part or all of the steering control. For example, when a travel distance after the vehicle passes through an influence section including an irregularity occurrence position becomes equal to or greater than a fourth threshold, the vehicle controller 17 may automatically restore a part or all of the steering control that has been suspended. The fourth threshold is a travel distance threshold of the vehicle for automatically returning a part or all of the steering control.

[Example of Operational Processing by ECU 10]

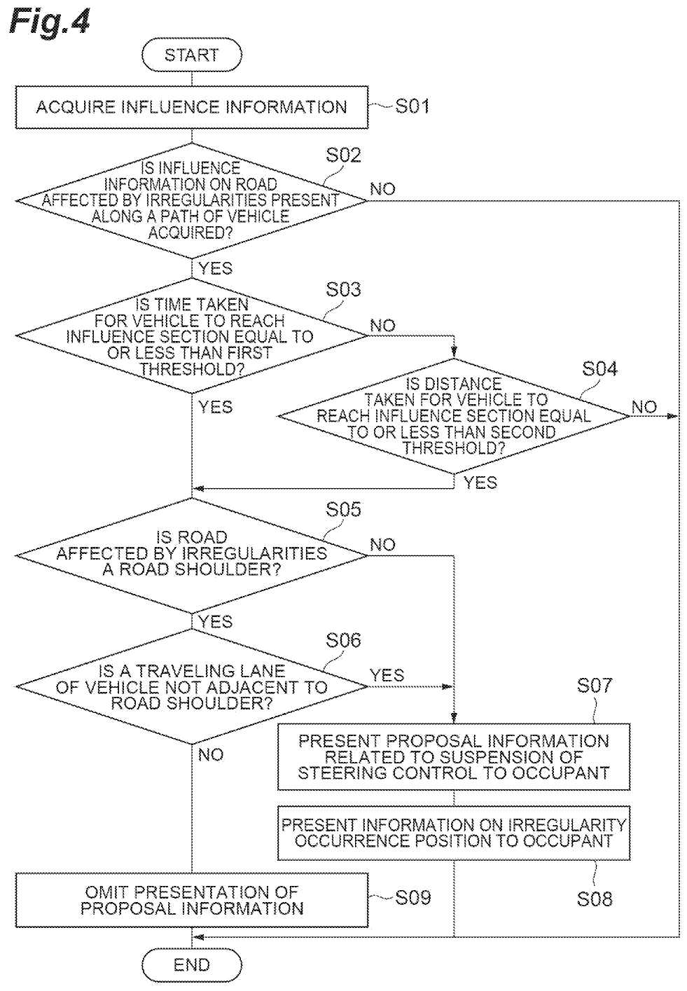

Next, an example of operational processing by ECU 10 will be described. FIG. 4 is a flow chart illustrating information presentation processing of the ECU of FIG. 1. The processing illustrated in FIG. 4 is repeatedly performed in a predetermined period during execution of steering control including steering assistance or automatic steering of the vehicle, for example. Each step (process) illustrated in FIGS. 4 to 6 constitutes the driving assistance method according to the embodiment.

As shown in FIG. 4, the ECU 10 acquires influence information by the influence information acquisition unit 14 in the S01. The influence information acquisition unit 14 acquires influence information stored in the influence information database 5 via communication, for example.

The ECU 10 determines whether influence information on the path of the vehicle is acquired by the proposal information presentation unit 15 in the S02. The proposal information presentation unit 15 determines whether the influence information on the path of the vehicle has been acquired based on, for example, the acquired influence information, the recognition result of the vehicle position recognition unit 11, and the map information.

When the proposal information presentation unit 15 determines that the influence information of the vehicle on the path is acquired in the S02, the ECU 10 determines whether the time until the vehicle reaches the influence section is equal to or less than the first threshold by the proposal information presentation unit 15 in the S03. The proposal information presentation unit 15 determines whether or not the time until the vehicle reaches the influence section is equal to or less than the first threshold based on, for example, the recognition result of the vehicle position recognition unit 11, the vehicle speed recognized by the traveling state recognition unit 12, and the irregularity occurrence position.

If the proposal information presentation unit 15 determines that the time required for the vehicle to reach the influence section is equal to or less than the first threshold (S03: YES), the ECU 10 transitions to S05. If the proposal information presentation unit 15 does not determine that the time taken for the vehicle to reach the influence section is equal to or less than the first threshold (S03: NO), the ECU 10 transitions to S04.

In the ECU 10, the proposal information presentation unit 15 determines whether or not the distance until the vehicle reaches the influence section is equal to or less than the second threshold in the S04. For example, based on the recognition result of the vehicle position recognition unit 11 and the irregularity occurrence position, the proposal information presentation unit 15 determines whether or not the distance until the vehicle reaches the influence section is equal to or less than the second threshold.

When it is determined by the proposal information presentation unit 15 that the distance until the vehicle reaches the influence section is equal to or less than the second threshold (S04: YES), the ECU 10 transitions to S05. In a case where the proposal information presentation unit 15 does not determine that the distance until the vehicle reaches the influence section is equal to or less than the second threshold (S04: NO), ECU 10 ends the processing of FIG. 4.

ECU 10 makes a determination by the proposal information presentation unit 15 in S05 whether the road affected by the irregularities is a road shoulder. The proposal information presentation unit 15 determines whether the road affected by the irregularities is a road shoulder based on, for example, the information on the road affected by the irregularities on the road and the irregularity occurrence position.

If the proposal information presentation unit 15 determines that the road affected by the irregularities is a road shoulder (S05: YES), the ECU 10 transitions to S06. If the proposal information presentation unit 15 does not determine that the road affected by the irregularities is a road shoulder (S05: NO), the ECU 10 transitions to S07.

In the ECU 10, the proposal information presentation unit 15 determines whether the traveling lane of the vehicle is not adjacent to the road shoulder in the S06. For example, the proposal information presentation unit 15 determines whether the traveling lane of the vehicle is not adjacent to the road shoulder based on the information on the road affected by the irregularities on the road, the irregularity occurrence position, and the recognition result of the vehicle position recognition unit 11.

If the proposal information presentation unit 15 determines that the traveling lane of the vehicle is not adjacent to the road shoulder (S06: NO), the ECU 10 transitions to S09. If the proposal information presentation unit 15 does not determine that the traveling lane of the vehicle is not adjacent to the road shoulder (S06: YES), the ECU 10 transitions to S07.

The ECU 10 presents proposal information on interruption of steering control to the occupant of the vehicle by the proposal information presentation unit 15 in the S07. The proposal information presentation unit 15 presents proposal information to the occupant of the vehicle by, for example, transmitting a control signal to the display of the HMI 6. The ECU 10 presents the information of irregularity occurrence position to the occupant by the proposal information presentation unit 15 in the S08. The proposal information presentation unit 15 presents information on the irregularity occurrence position to the occupant of the vehicle by transmitting a control signal to the display of the HMI 6, for example. Thereafter, the ECU 10 ends the processing of FIG. 4.

On the other hand, ECU 10 omits presentation of proposal information by the proposal information presentation unit 15 in S09. The proposal information presentation unit 15 omits presentation of proposal information by, for example, not transmitting a control signal to the HMI 6. Thereafter, the ECU 10 ends the processing of FIG. 4.

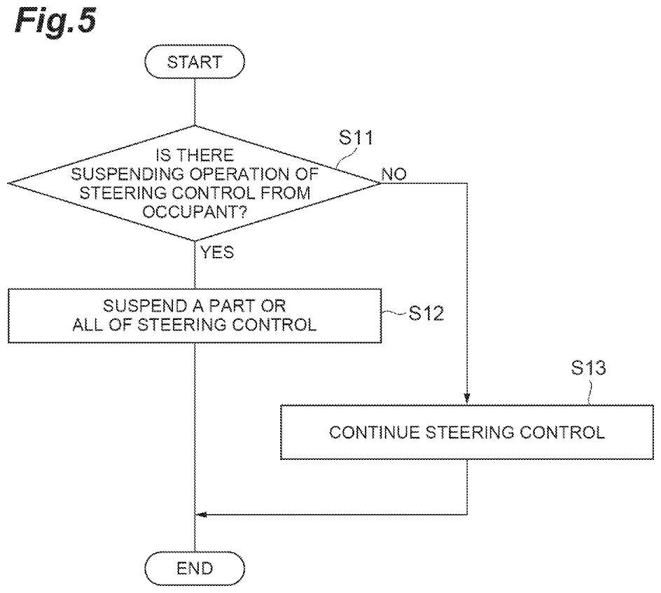

FIG. 5 is a flow chart illustrating support suspension processing of the ECU of FIG. 1. The processing illustrated in FIG. 5 is repeatedly performed in a predetermined period in a case where proposal information related to interruption of steering control is presented to an occupant of a vehicle (the above S07) while steering control including steering assistance or automatic steering of the vehicle is being performed, for example.

The ECU 10 determines whether or not there was a suspending operation of the steering control from the occupant by the vehicle controller 17 in the S11. The vehicle controller 17 determines whether there is a suspending operation of steering control from an occupant based on whether the suspending operation is received in HMI 6, for example.

If the vehicle controller 17 determines that there has been a suspending operation of steering control from the occupant (S11: YES), the ECU 10 transitions to S12. The ECU 10 interrupts some or all of the steering controls by the vehicle controller 17 in the S12. For example, the vehicle controller 17 suspends some or all of the steering controls in accordance with the content of the proposal information presented to the occupant. Thereafter, the ECU 10 ends the processing of FIG. 5. The ECU 10 may continue the steering control until a part or all of the steering control is interrupted (transition time).

On the other hand, if the vehicle controller 17 does not determine that there has been a suspending operation of steering control from the occupant (S11: NO), the ECU 10 transitions to S13. The ECU 10 continues steering control by the vehicle controller 17 in the S13. Thereafter, the ECU 10 ends the processing of FIG. 5.

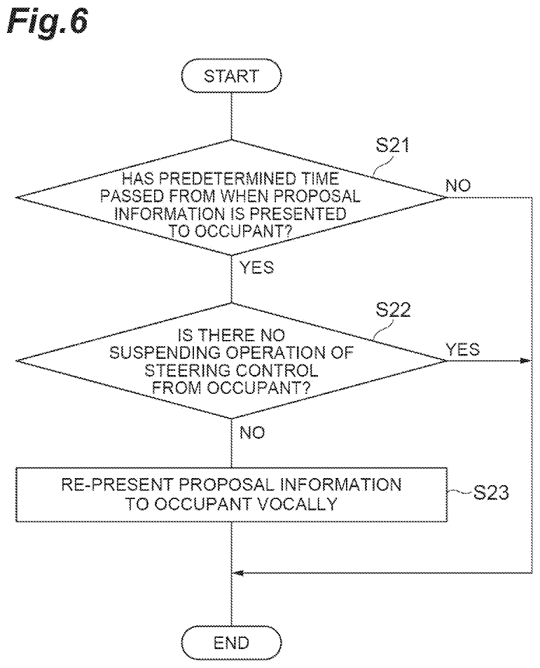

FIG. 6 is a flow chart illustrating information re-presentation processing of the ECU of FIG. 1. The processing illustrated in FIG. 6 is repeatedly performed in a predetermined period, for example, when proposal information regarding suspension of steering control is presented to an occupant of a vehicle (S07) while steering control including steering assistance or automatic steering of the vehicle is being performed, and when the vehicle controller 17 does not determine that suspending operation of steering control from the occupant has occurred (S11: NO).

In the ECU 10, the proposal information presentation unit 15 determines whether or not the predetermined time has elapsed since the proposal information was presented to the occupant (S21). For example, the proposal information presentation unit 15 determines whether or not the elapsed time from when the proposal information is presented to the occupant of the vehicle (the S07) exceeds a predetermined time set in advance based on whether or not the elapsed time exceeds the predetermined time set in advance.

If it is determined by the proposal information presentation unit 15 that the predetermined time has been exceeded since the proposal information was presented to the occupant (S21: YES), the ECU 10 transitions to S22. If the proposal information presentation unit 15 does not determine that the predetermined time has been exceeded since the proposal information was presented to the occupant (S21: NO), the ECU 10 ends the processing of FIG. 6.

The ECU 10 determines whether there is no suspending operation of the steering control from the occupant by the proposal information presentation unit 15 in the S22. For example, the proposal information presentation unit 15 determines whether there is no suspending operation of steering control from the occupant based on whether the suspending operation can be detected in the HMI 6.

If it is determined by the proposal information presentation unit 15 that there is no suspending operation of steering control from the occupant (S22: NO), the ECU 10 transitions to S23. The ECU 10 represents the proposal information in audio to the occupant by the proposal information presentation unit 15 in S23. For example, the proposal information presentation unit 15 transmits a control signal to a speaker of the HMI 6 to re-present the proposal information to the occupant in audio. After that, the ECU 10 ends the processing of FIG. 6 and performs the processing of FIG. 5.

On the other hand, if the proposal information presentation unit 15 does not determine that there is no suspending operation of the steering control from the occupant (S22: YES), the ECU 10 ends the processing of FIG. 6. In addition, the ECU 10 may stop the vehicle by operating a predetermined risk minimization control when the suspending operation of the steering control from the occupant is not confirmed even after a predetermined limit time elapses and the driving is not taken over by the occupant.

According to the driving assistance apparatus 100 described above, influence information including information on a road affected by the irregularities on the road is acquired by the influence information acquisition unit 14. When influence information on the irregularities on the road along the path of the vehicle is acquired while the steering control is being performed, the proposed information regarding the interruption of the steering control is presented to the occupant of the vehicle by the proposal information presentation unit 15. The occupant of the vehicle is given an opportunity to examine whether or not to continue steering control based on the proposed proposal information. Some or all of the steering control is suspended based on the suspending operation of the steering control from the occupant. Therefore, it is possible to provide room for the occupant's intention to intervene in the continuing execution of the driving assistance when irregularities on the road are present on the path of the vehicle.

In the driving assistance apparatus 100, influence information includes information of irregularity occurrence position on the road associated with the irregularities. When influence information on the path of the vehicle is acquired during steering control, the proposal information presentation unit 15 presents information on the irregularity occurrence position to the occupant. Accordingly, the occupant of the vehicle may consider whether to continue the steering control in consideration of the information of the irregularity occurrence position.

In the driving assistance apparatus 100, influence information includes information of irregularity occurrence position on the road associated with the irregularities. The proposal information presentation unit 15 presents proposal information to the occupant when the time until the vehicle reaches the influence section including the irregularity occurrence position is equal to or less than a first threshold or when the length until the vehicle reaches the influence section is equal to or less than a second threshold. Accordingly, the occupant of the vehicle can examine in advance whether to continue the steering control before the vehicle reaches the influence section.

In the driving assistance apparatus 100, if there is no suspending operation of the steering control from the occupant within a predetermined time after presenting the proposal information to the occupant, the proposal information presentation unit 15 re-presents the proposal information to the occupant in audio. By re-presenting the proposal information, for example, an occupant who fails to recognize the proposal information can be given an opportunity to examine whether or not to continue the steering control based on the re-presented proposal information.

In the driving assistance apparatus 100, the proposal information presentation unit 15 omits presentation of proposal information if the road affected by the irregularities is a road shoulder and the traveling lane of the vehicle is not adjacent to the road shoulder. In particular, if the road affected by the irregularities is a road shoulder and the traveling lane of the vehicle is not adjacent to the road shoulder, the vehicle is spaced apart by at least a 1 lane adjacent to the road shoulder relative to the irregularities. The traveling lane of the vehicle is less affected by the irregularities on the road than if the road affected by the irregularities is a road shoulder and the traveling lane of the vehicle is adjacent to the road shoulder. In response to the influence being relatively small and the possibility of continuing the steering control being relatively high, presentation of proposal information is omitted. As a result, it is possible to give the occupant of the vehicle an opportunity to examine whether or not to continue the steering control according to the magnitude of the influence of the irregularities on the road on the lane in which the vehicle is traveling.

The driving assistance method according to the above embodiment acquires influence information including information on a road affected by the irregularities on the road, presents proposal information on suspension of steering control to an occupant of the vehicle when influence information on a path of the vehicle is acquired during steering control including steering assistance or automatic steering of the vehicle, and suspends part or all of the steering control based on suspending operation of the steering control from the occupant.

In the driving assistance method according to the above-described embodiment, influence information including information on a road affected by the irregularities on the road is acquired. When influence information on the path of the vehicle is acquired during execution of steering control, proposal information related to interruption of steering control is presented to an occupant of the vehicle. The occupant of the vehicle is given an opportunity to examine whether or not to continue steering control based on the proposed proposal information. Some or all of the steering control is suspended based on the suspending operation of the steering control from the occupant.

Therefore, it is possible to provide room for the occupant's intention to intervene in the continuing execution of the driving assistance when irregularities on the road are present on the path of the vehicle.

[Modification]

Although the embodiments of the present disclosure have been described above, the present disclosure is not limited to the above-described embodiments. The present disclosure can be implemented in various forms in which various modifications and improvements are made based on knowledge of one skilled in the art, including the above-described embodiments.

The proposal information presentation unit 15 may not necessarily present the information of the irregularity occurrence position to the occupant. In this case, the influence information may not include information on an irregularity occurrence position on a road associated with the irregularities.

The proposal information presentation unit 15 may present the proposal information to the occupant without determining whether or not the time until the vehicle reaches the influence section is equal to or less than the first threshold. The proposal information presentation unit 15 may present the proposal information to the occupant without determining whether or not the length until the vehicle reaches the influence section is equal to or less than the second threshold.

Even when there is no suspending operation of steering control from the occupant within a predetermined time after the proposal information is presented to the occupant, the proposal information presentation unit 15 may not re-present the proposal information to the occupant in audio.

The proposal information presentation unit 15 may present proposal information even if the road affected by the irregularities is a road shoulder and the traveling lane of the vehicle is not adjacent to the road shoulder. Alternatively, the proposal information presentation unit 15 may omit presentation of proposal information if the road affected by the irregularities is not adjacent to the traveling lane of the vehicle.

The above-described embodiment and modifications may be combined with each other.

In the above-described embodiment and modifications, the driving assistance apparatus 100 is configured to be able to execute autonomous driving, but in some embodiments execution of autonomous driving may not be performed. The driving assistance apparatus 100 may be configured to execute steering control including steering assistance or automatic steering of the vehicle. In this case, a configuration for performing autonomous driving, which is not used for steering control including steering assistance or automatic steering (the trajectory generation unit 16 or the like) may be omitted.

What is claimed is:

1. A driving assistance apparatus capable of executing steering control that includes steering assistance or automatic steering of a vehicle, the driving assistance apparatus comprising:
an influence information acquisition unit configured to acquire influence information including information on a road affected by irregularities on the road;
a proposal information presentation unit configured to present proposal information related to suspension of the steering control to an occupant of the vehicle, when the influence information on road affected by irregularities present along a path of the vehicle is acquired during execution of the steering control; and
a steering control unit configured to suspend a part or all of the steering control based on a suspending operation of the steering control from the occupant.

2. The driving assistance apparatus according to claim 1,
wherein the influence information includes information on irregularity occurrence positions on the road associated with the irregularities, and
wherein the proposal information presentation unit is configured to present information on the irregularity occurrence position to the occupant, when the influence information on road affected by irregularities present along the path of the vehicle is acquired during the execution of the steering control.

3. The driving assistance apparatus according to claim 1,
wherein the influence information includes information on irregularity occurrence positions on the road associated with the irregularities, and
wherein the proposal information presentation unit is configured to present the proposal information to the occupant when a time taken for the vehicle to reach an influence section including the irregularity occurrence position is equal to or less than a first threshold, or when a distance taken for the vehicle to reach the influence section is equal to or less than a second threshold.

4. The driving assistance apparatus according to claim 1,
wherein the proposal information presentation unit is configured to re-present the proposal information to the occupant vocally, when there is no suspending operation of the steering control from the occupant within a predetermined time from when the proposal information presentation unit presents the proposal information to the occupant.

5. The driving assistance apparatus according to claim 1,
wherein the proposal information presentation unit is configured to omit presentation of the proposal information, when the road affected by irregularities is a road shoulder and a traveling lane of the vehicle is not adjacent to the road shoulder.

6. A driving assistance method comprising:
acquiring influence information that includes information on a road affected by irregularities on the road;
presenting proposal information related to suspension of steering control to an occupant of a vehicle when the influence information on road affected by irregularities present along a path of the vehicle is acquired during execution of a steering control that includes steering assistance or automatic steering of the vehicle; and
suspending a part or all of the steering control, based on a suspending operation of the steering control from the occupant.
